(19) United States
(12) Patent Application Publication
(10) Pub. No.: US 2008/0183862 A1
(43) Pub. Date: Jul. 31, 2008

(54) NETWORK COMMUNICATION MANAGEMENT SYSTEM INCLUDING NETWORK WITH IMPROVED SAFETY AND RELIABILITY

(76) Inventor: ATARU KOBAYASHI, Tokyo (JP)

Correspondence Address: NEC CORPORATION OF AMERICA, 6535 N. STATE HWY 161, IRVING, TX, 75039, US

(21) Appl. No.: 12/022,323

(22) Filed: Jan. 30, 2008

(30) Foreign Application Priority Data
Jan. 31, 2007 (JP) 2007-021334

(51) Int. Cl. G06F 15/173

(52) U.S. Cl. 709/224

(57) ABSTRACT

A network communication management system of the present invention comprises a maintenance server connected to a network and a terminal connected to the network via a gateway. The terminal transmits terminal information indicating an operating state of the terminal to the maintenance server via said gateway. When the maintenance server receives the terminal information via the gateway, the maintenance server transmits specific information for causing the terminal to perform specific processing based on the terminal information to the terminal via the gateway.

This application is based upon and claims the benefit of priority from Japanese Patent Application No. 2007-21334 filed on Jan. 31, 2007, the content of which is incorporated by reference.

### BACKGROUND OF THE INVENTION

1. Field of the Invention

The present invention relates to a network communication management system, a terminal, a maintenance server, a network communication management method, a program for causing a computer to perform the method, and a storage medium for recording the program such that the program can be read by the computer.

2. Description of the Related Art

Networks called Next Generation Networks (NGNs) are expected to be further applied to home networks, multimedia and so on for performing control from the outside of Internet Protocol (IP) telephones and terminals installed in houses while being connected via networks.

Further, terminals (e.g., a refrigerator, an air conditioner) connected to such networks have remarkably improved in performance and functionality with connectivity and convenience. Meanwhile, security measures for preventing unauthorized access to these terminals have become urgently necessary.

Networks connected to wired phones and switchboards are called legacy networks. In a system based on switchboards in such a legacy network, the operating states of terminals connected to the network and the state of an interface are kept track of and managed. Thus in the event of a failure such as concentrated calls, the failure is resolved and recovery is made by interrupting the transmission of calls from the network to the terminals or controlling the interface. In such a legacy network, a carrier acting as a network administrator manages the terminals and the interface in the end and thus connection, interruption and so on can be controlled by a hardware configuration, achieving reliable control and protection.

On the other hand, in the field of Internet where the number of users has dramatically increased in the present circumstances, the kinds and number of terminals connected to the Internet via interfaces reach astronomical figures, and the connected terminals have been remarkably improved in functionality and become difficult to control. In other words, generally in the Internet, data transmission to terminals including interfaces is not limited and thus data transmitted to the Internet is inputted as it is to the terminals via the interfaces. The Internet is a best-effort network not guaranteeing the quality of communications and is configured such that which terminal is connected to which place cannot be recognized. Therefore, if a failure occurs in the interface of a terminal or the body of the terminal, the terminal user has to resolve the failure and recover from the failure by him/herself at his/her own risk. Once a failure occurs, the recovery involves quite a number of difficulties in most cases.

In the Internet, connected terminals have been sophisticated with expanded functionality, and interfaces and networks that are connected to terminals have been also dramatically sophisticated. Therefore, when congestions occur in communications or if a failure or a breakdown occurs in a terminal or an interface, the handling becomes extremely difficult and complicated. Further, against attacks to networks and terminals from the outside, the only one solution for users is to install application software, so that the users are forced into unsafe operations.

In this way, terminals in IP communications have been remarkably sophisticated with higher functionality and it is quite important to take various maintenance measures including measures against failures occurring in terminals and interfaces, measures against vulnerability, security measures, and measures against congestions.

In other words, in the aforementioned network, convenience, connectivity, safety, reliability, maintainability, and operability are demanded. In terminals connected to the network, it is desired to handle complicated failures or breakdowns that are caused by expanded terminal functionality and the sophistication of the terminals and network. Further, measures against attacks and threat from the outside are demanded for the network and terminals.

However, in the event of a breakdown in a terminal of a present network, the user generally has to find the point of breakdown and repair the terminal by him/herself or ask a professional to repair the terminal. Thus users with different levels of knowledge about the network and terminals have to separately handle breakdowns, so that the handling of breakdowns becomes burdensome to users having insufficient knowledge about the network and terminals. Also to professionals, the handling of sophisticated terminals is seriously complicated. Moreover, the repair cost increases.

### SUMMARY OF THE INVENTION

An object of the present invention is to provide a network communication management system, a terminal, a maintenance server, a network communication management method, a program for causing a computer to perform the method, and a recording medium for recording the program such that the program can be read by the computer, by which a network takes the lead in achieving the convenience, connectivity, safety, reliability, maintainability and operability of terminals.

A network communication management system of the present invention comprises a maintenance server connected to a network; and a terminal connected to the network via a gateway, wherein the terminal transmits terminal information indicating an operating state of the terminal to the maintenance server via the gateway, and when the maintenance server receives the terminal information via the gateway, the maintenance server transmits specific information for causing the terminal to perform specific processing based on the terminal information to the terminal via the gateway.

According to the present invention, it is possible to easily ensure connectivity, safety, reliability, maintainability, operability and so on for terminals by managing the terminals from a network, and construct a network system connected to the sophisticated terminals.

The above and other objects, features and advantages of the present invention will become apparent from the following description with reference to the accompanying drawings which illustrate examples of the present invention.

### BRIEF DESCRIPTION OF THE DRAWINGS

FIG. 1 illustrates a structural example of a network communication management system according to an exemplary embodiment;

FIG. 2 is a block diagram showing a structural example of a terminal;

FIG. 3 is a block diagram showing a structural example of a maintenance server;

FIG. 4 is a flowchart showing the operating procedure of the network communication management system according to the exemplary embodiment;

FIG. 5 is a block diagram showing a structural example of a network communication management system according to a first exemplary embodiment;

FIG. 6 is a block diagram showing a structural example of a trouble-shooting server;

FIG. 7 illustrates the operating procedure of the first exemplary embodiment;

FIG. 8 illustrates the operating procedure of a second exemplary embodiment;

FIG. 9 illustrates the operating procedure of a third exemplary embodiment;

FIG. 10 illustrates the operating procedure of a fourth exemplary embodiment;

FIG. 11 illustrates the operating procedure of a fifth exemplary embodiment; and

FIG. 12 illustrates the operating procedure of a sixth exemplary embodiment.

### DETAILED DESCRIPTION OF THE PREFERRED EMBODIMENTS

An exemplary embodiment includes a program for causing a computer to perform a system operating procedure discussed below and includes a storage medium for storing the program. A network communication management system of the present exemplary embodiment is applicable to a NGN.

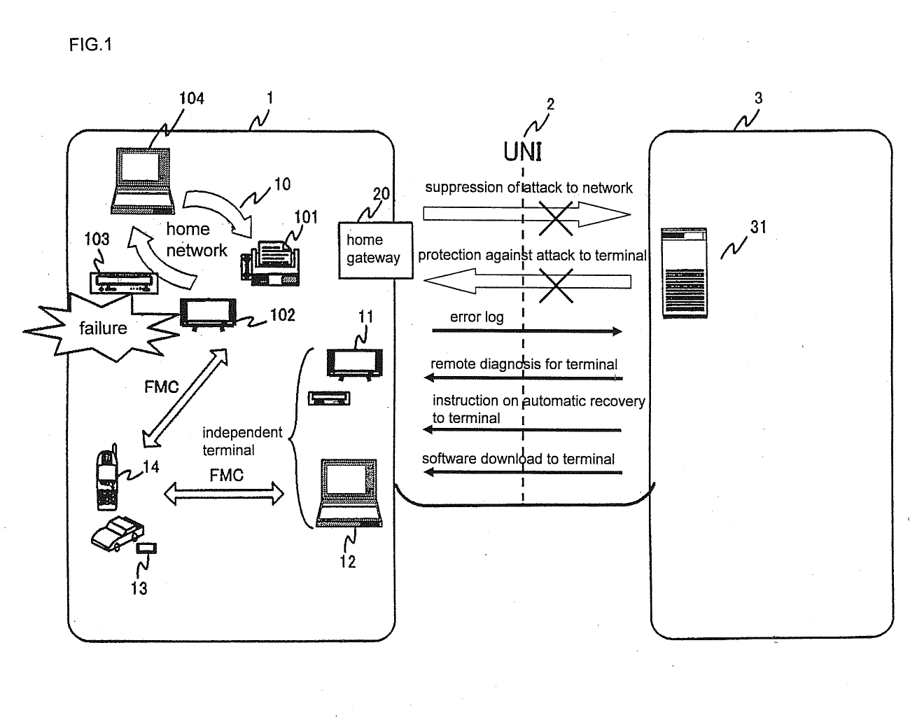

FIG. 1 illustrates a structural example of the network communication management system according to the exemplary embodiment.

In the present exemplary embodiment, terminals provided in a house are connected to User Network Interface (UNI) 2 via home gateway 20. UNI 2 is connected to network 3. Network 3 is, e.g., the Internet. The house where the terminals are provided will be referred to as terminal side 1.

Terminal side 1 includes home network 10 connecting terminals such as telephone/fax machine 101, digital television 102, video recorder 103, and personal computer 104. Further, these terminals are connected to UNI 2 via home gateway 20.

Meanwhile, terminals such as audio-visual apparatus 11, personal computer 12, car navigation system 13, and cellular phone 14 are not connected to home network 10. The terminals not connected to home network 10 each include communication means for connection to UNI 2.

The terminals connected thus to UNI 2 are designed for Fixed Mobile Convergence (FMC) that is a technique of using the same terminal in both of mobile communications and wire communications according to the location and circumstances. Thus the terminals can be used as either wired phones or mobile electronic equipment.

Maintenance server 31 is connected to network 3. Maintenance server 31 stored in network 3 performs not only operations relating to normal calling but also various kinds of control (maintenance, monitoring, repair, file update and so on of an operating system) as will be discussed later.

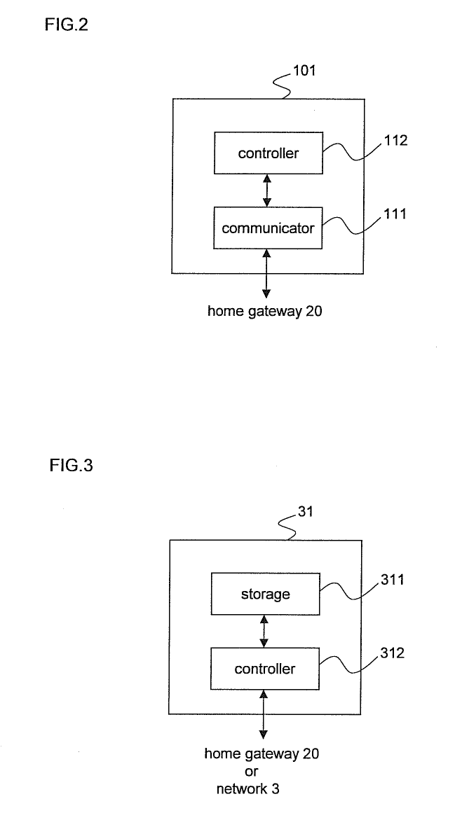

The following is the configuration of the terminal provided in the house. FIG. 2 is a block diagram showing a structural example of the terminal. As a representative example of the terminal, the configuration of telephone/fax machine 101 will be discussed below. Since the telephone function and the facsimile function of telephone/fax machine 101 are similar to typical functions, the detailed explanation thereof is omitted and only a part relating to the present invention will be specifically described.

As shown in FIG. 2, telephone/fax machine 101 includes communicator 111 for communicating with home gateway 20 and controller 112 for performing various kinds of processing. Controller 112 includes a Central Processing Unit (CPU, not shown) for performing the processing according to a program and a memory (not shown) for storing the program.

Controller 112 monitors the operating state of the machine and transmits terminal information to maintenance server 31 via communicator 111 in each period of time. The terminal information indicates the operating state of the machine. Further, when controller 112 receives specific information for causing the terminal to perform specific processing determined based on the terminal information, controller 112 performs the specific processing according to the specific information. The terminal information may include log information indicating the history of the operating states of the terminal.

Although controller 112 is supposed to transmit the terminal information to maintenance server 31 in each period of time, controller 112 may transmit the terminal information to maintenance server 31 when receiving, from maintenance server 31, instruction information for instructing the transmission of the terminal information.

The following is the configuration of maintenance server 31. FIG. 3 is a block diagram showing a structural example of the maintenance server. Maintenance server 31 includes storage 311 for storing information about specific processing for handling an abnormality of the terminal and controller 312 for performing processing according to terminal information. Storage 311 stores a trouble-shooting software program for eliminating a failure in the terminal. Controller 312 includes a CPU (not shown) for performing the processing according to the program and a program memory (not shown) for storing the program.

When controller 312 receives terminal information from the terminal, controller 312 determines the specific processing performed by the terminal based on the terminal information and transmits specific information including information about the specific processing to the terminal via home gateway 20. A specific example of the specific processing will be described in an operating procedure discussed later.

Home gateway 20 is an interface device for connecting networks such as network 3 and UNI 2 that are compliant with different kinds of communication standards. A configuration and an operation for the function of home gateway 20 are similar to those of a typical gateway, and thus the detailed explanation thereof is omitted.

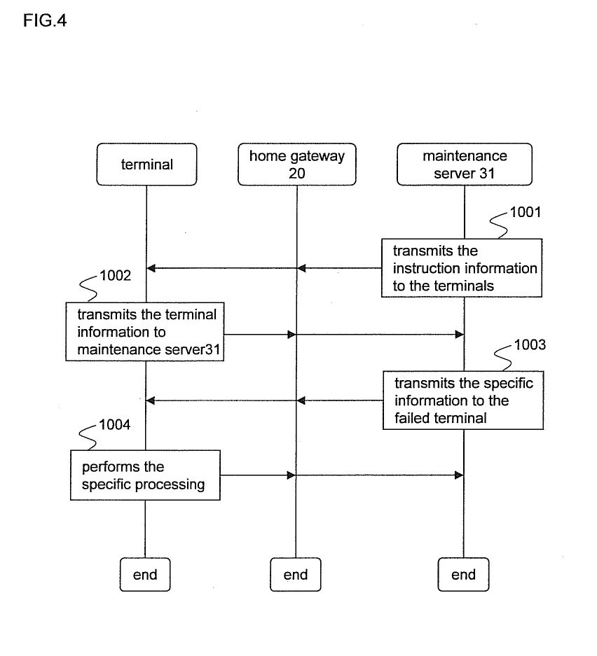

The following is the operating procedure of the network communication management system according to the present exemplary embodiment. FIG. 4 is a flowchart showing the operating procedure.

Maintenance server 31 transmits the instruction information to the terminals in terminal side 1 via UNI 2 and home gateway 20 to diagnose the operating states of the terminals (step 1001). When the terminals in terminal side 1 receive the instruction information for diagnoses, the terminals transmit terminal information indicating the operating states of the terminals based on the instruction information, to maintenance server 31 via home gateway 20 and UNI 2 (step 1002). The terminal information may include log information.

When maintenance server 31 receives the terminal information from the terminals, maintenance server 31 confirms the operating states of the terminals. When maintenance server 31 diagnoses the presence or absence of a failure in the terminals and recognizes a failure in a terminal, maintenance server 31 transmits specific information to the failed terminal via UNI 2 and home gateway 20, the specific information including information about automatic recovery for proper recovery corresponding to the contents of the failure (step 1003). The automatic recovery corresponds to the specific processing. The failed terminal performs the specific processing included in the specific information when receiving the specific information from maintenance server 31 (step 1004).

When the information about automatic recovery is the optimum software program for handling a failure of the terminal based on information about the failure, the terminal executes the software program and recovers from the failure, so that the terminal returns to a normal operating state.

In order to prevent failures in the terminals, maintenance server 31 may upgrade or update an application program or software program for allowing the terminals to perform the functions.

When the program has to be upgraded or updated and a new program is registered in storage 311, controller 312 of maintenance server 31 transmits the program to the terminals. When receiving the program from maintenance server 31, the terminals store the received program in the memories (not shown) of controllers 112 and erase the earlier version. The programs in the terminals are upgraded thus.

Maintenance server 31 is supposed to be a carrier acting as an administrator of network 3. The carrier blocks threat caused by the invasion of computer viruses to UNI 2 from the outside, by means of a special interface. Therefore, the carrier independently manages the terminals including telephone/fax machine 101 to personal computer 104 that are connected to home network 10, the independent terminals including audio-visual apparatus 11 to cellular phone 14, and UNI 2, so that the carrier can independently manage operations.

When data transmission to a specific terminal is congested, the carrier can also control the network so as to bypass a node or regulate calls and so on. Moreover, as described above, the carrier can perform various kinds of control. To be specific, an executive program for proper recovery can be transmitted to a target terminal via network 3 according to the state of a failure of the terminal.

In the present exemplary embodiment, the network manager controls the network and independently controls the terminals connected via UNI 2 acting as an interface. Therefore, it is possible not only to ensure maintenance over the system made up of the terminals and the network, but also to achieve a quick response in the event of various problems such as a failure in a terminal and congested data transmission to the terminal.

The following will describe exemplary embodiments with reference to the accompanying drawings. In the exemplary embodiments, a trouble-shooting server for handling a failure in a terminal is provided for each terminal manufacturer.

### First Exemplary Embodiment

In the present exemplary embodiment, terminals are not failed but are normally operated. FIG. 5 is a block diagram showing a structural example of a network communication management system according to the present exemplary embodiment.

In the present exemplary embodiment, as shown in FIG. 5, terminal 101A manufactured by company A and terminal 101B manufactured by company B are provided on terminal side 1. Terminal 101A and terminal 101B are connected to home network 10. Server 4A acting as the trouble-shooting server of company A and server 4B acting as the trouble-shooting server of company B are connected to network 3.

The number of terminals and the number of trouble-shooting servers are not limited to two. Further, the terminals may be independent terminals unconnected to home network 10.

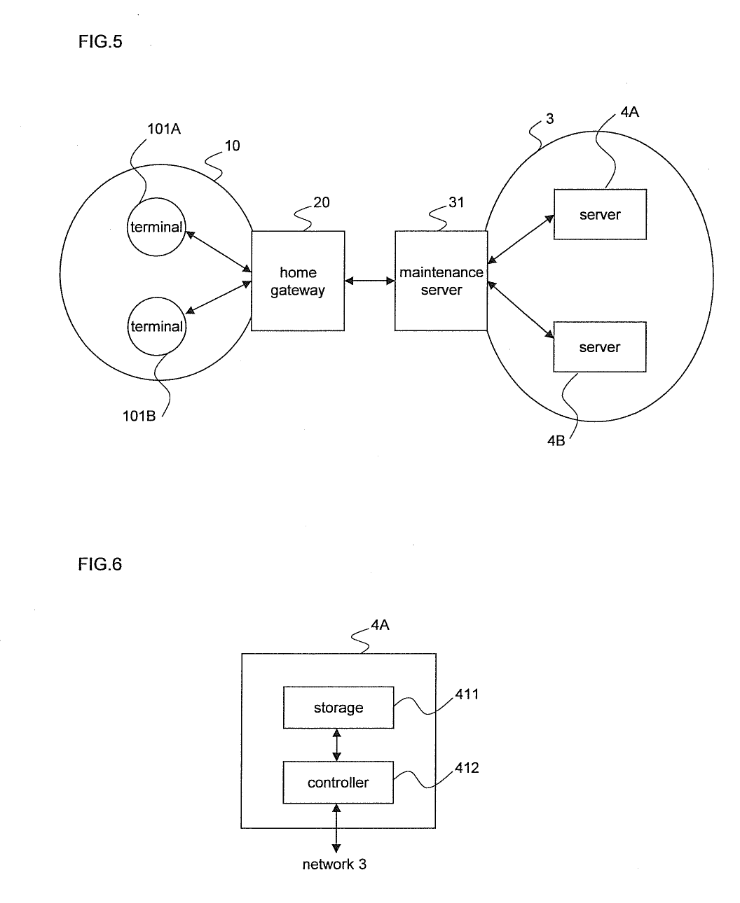

FIG. 6 is a block diagram showing a structural example of the trouble-shooting server. Since server 4A and server 4B are identical in configuration, the configuration of server 4A will be described as a representative example.

Server 4A includes storage 411 which stores information for handling an abnormality of terminal 101A and controller 412 which performs processing according to terminal information. Controller 412 includes a CPU (not shown) for performing the processing according to a program and a program memory (not shown) for storing the program.

The information stored in storage 411 includes a program for handling a failure in terminal 101A and includes past failure information. The program of this case corresponds to information about specific processing. When various kinds of terminals are provided, the program for handling a failure and the past failure information are registered in storage 411 so as to correspond to model information for identifying the model of the terminal. The model information includes the manufacturer's name, category, and version information of the terminal. When the model can be identified by only one of the category and the version, the model information may include only one of the category and the version of terminal.

Controller 412 receives terminal information from maintenance server 31. When the terminal information includes model information, controller 412 identifies the model of terminal 101A based on the model information. Further, controller 412 confirms whether terminal 101A operates normally or abnormally based on the terminal information. When controller 412 recognizes that terminal 101A abnormally operates, controller 412 reads, from storage 411, the program for handling the failure of the identified model and transmits specific information including the program to terminal 101A via maintenance server 31.

Further, information for handling a failure in terminal 101B is stored in server 4B. Server 4B is identical in configuration to server 4A and thus the detailed explanation thereof is omitted. When various kinds of terminals are provided for company B, information for handling a failure is stored for each model. Server 4B operates in a similar manner to server 4A in response to terminal information received from terminal 101B.

When maintenance server 31 receives the specific information from the trouble-shooting servers, maintenance server 31 may perform processing on the terminals based on the measures of the specific information. This processing for maintenance is enabled because the system allows maintenance server 31 to manage and control the terminals.

In terminal 101A and terminal 101B of the present exemplary embodiment, the model information about the terminal is stored beforehand in the memory (not shown) of controller 112. Controller 112 transmits the terminal information including the model information to maintenance server 31. Home gateway 20 confirms the contents of the terminal information received from terminal 101A and terminal 101B, and transmits information indicating the operating states of the terminals, to maintenance server 31 in response to information obtained from the terminal information. In this case, it is possible to reduce the number of times that information is transmitted from home gateway 20 to maintenance server 31.

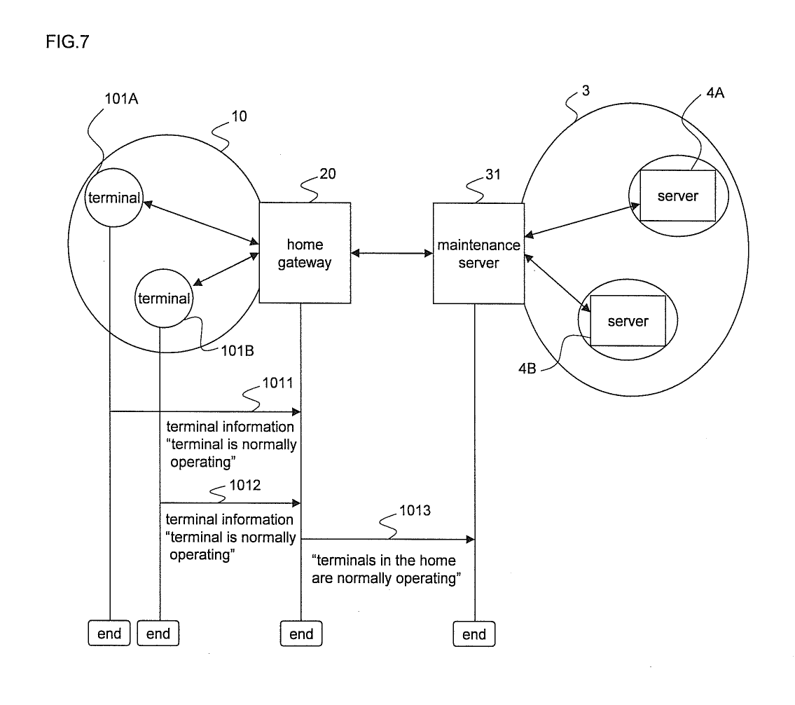

The following is the operating procedure of the network communication management system according to the present exemplary embodiment. FIG. 7 is a flowchart showing the operating procedure of the present exemplary embodiment.

Terminal 101A and terminal 101B transmit terminal information including model information to maintenance server 31 via home gateway 20 respectively (steps 1011, 1012). Home gateway 20 confirms the operating states of the terminals when receiving the terminal information from terminal 101A and terminal 101B. When home gateway 20 confirms that both of the terminals normally operate, home gateway 20 transmits information indicating that “terminals in the home are normally operating” to maintenance server 31 (step 1013). In this way, the terminal information can be collectively transmitted to maintenance server 31.

In the present exemplary embodiment, home gateway 20 confirms the contents of terminal information when receiving the terminal information from terminal 101A and terminal 101B. Home gateway 20 may transfer information to the maintenance server without confirming the contents. In this case, maintenance server 31 confirms whether the terminal operates normally or abnormally based on the received terminal information. As shown in FIG. 7, terminal information indicating normal conditions is transmitted from terminal 101A and terminal 101B. Thus maintenance server 31 recognizes that the terminals in the home normally operate.

In the present exemplary embodiment, as described above, programs for maintenance and recovery from a failure are stored in server 4A and server 4B. The programs for handling failures are transmitted from the trouble-shooting servers to maintenance server 31 to cause maintenance server 31 to perform necessary processing, thereby eliminating failures in the terminals. Further, the program for handling a failure is transmitted to a target terminal via home gateway 20, thereby eliminating a failure in the terminal.

Moreover, server 4A and server 4B may store information and programs for upgrading the terminals respectively, and the information and programs may be downloaded from the trouble-shooting servers to the terminals to be upgraded.

### Second Exemplary Embodiment

The present exemplary embodiment will describe operations when an abnormality occurs in a terminal. The explanation of the same configuration and operations as the first exemplary embodiment is omitted and only points different from the first exemplary embodiment will be specifically described below.

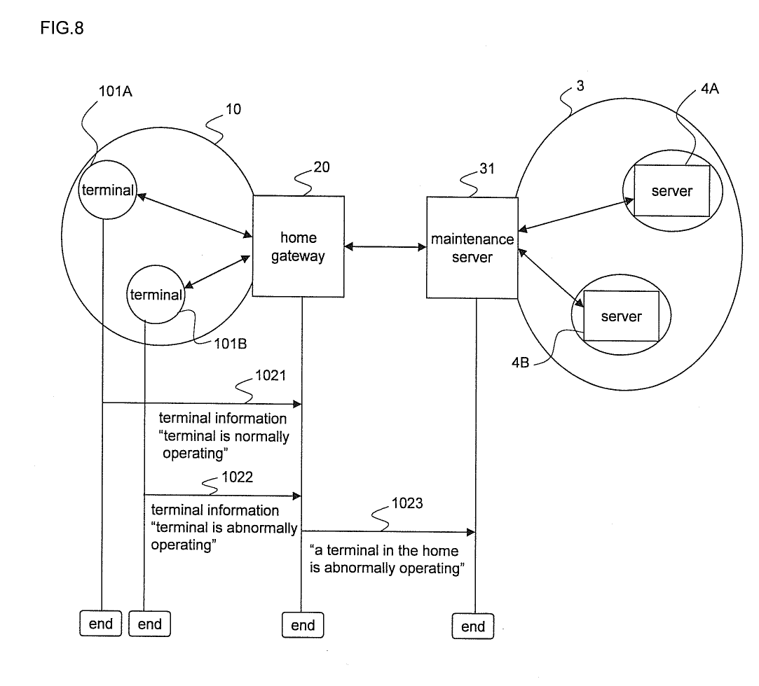

FIG. 8 is a flowchart showing the operating procedure of the present exemplary embodiment. In this case, terminal 101A normally operates and terminal 101B abnormally operates.

Terminal 101A and terminal 101B transmit terminal information including model information to maintenance server 31 via home gateway 20 respectively (steps 1021, 1022). Home gateway 20 confirms the operating states of the terminals when receiving the terminal information from terminal 101A and terminal 101B. When home gateway 20 confirms that terminal 101B abnormally operates, home gateway 20 transmits information indicating that “a terminal in the home is abnormally operating” to maintenance server 31 (step 1023).

Home gateway 20 may insert model information about the abnormal terminal in information to be transmitted to maintenance server 31. In the present exemplary embodiment, home gateway 20 confirms the contents of terminal information when receiving the terminal information from terminal 101A and terminal 101B. Home gateway 20 may transfer information to the maintenance server without confirming the contents. In this case, maintenance server 31 receives terminal information which has model information and indicates a normal operation from terminal 101A, and receives terminal information which has model information and indicates an abnormal operation from terminal 101B. Thus maintenance server 31 can identify terminal 101B based on the model information and confirm an abnormality in terminal 101B.

Further, maintenance server 31 transfers terminal information about terminal 101B to server 4B. When maintenance server 31 receives, from server 4B, specific information including trouble-shooting information, maintenance server 31 carries out measures for terminal 101B. These measures may be carried out by an operator who operates maintenance server 31. Further, these measures may be carried out by transmitting a trouble-shooting program stored in server 4B to terminal 101B, installing the trouble-shooting program in terminal 101B, and causing terminal 101B to execute the trouble-shooting program.

### Third Exemplary Embodiment

The present exemplary embodiment will describe operations when maintenance server 31 collects log information about terminals, recognizes the state of a failure in the terminals, and carries out the measures. The explanation of the same configuration and operations as the first exemplary embodiment is omitted and only points different from the first exemplary embodiment will be specifically described below.

Generally, log information is records of computer usage and data communications. In this case, log information is usage information about terminals and records of data communications. Log information may further include dates and times at which operations are performed or data is transmitted or received, may include information about the contents of performed operations, and may include the contents of transmitted or received data. Log information corresponds to history information about the operating states of the terminal.

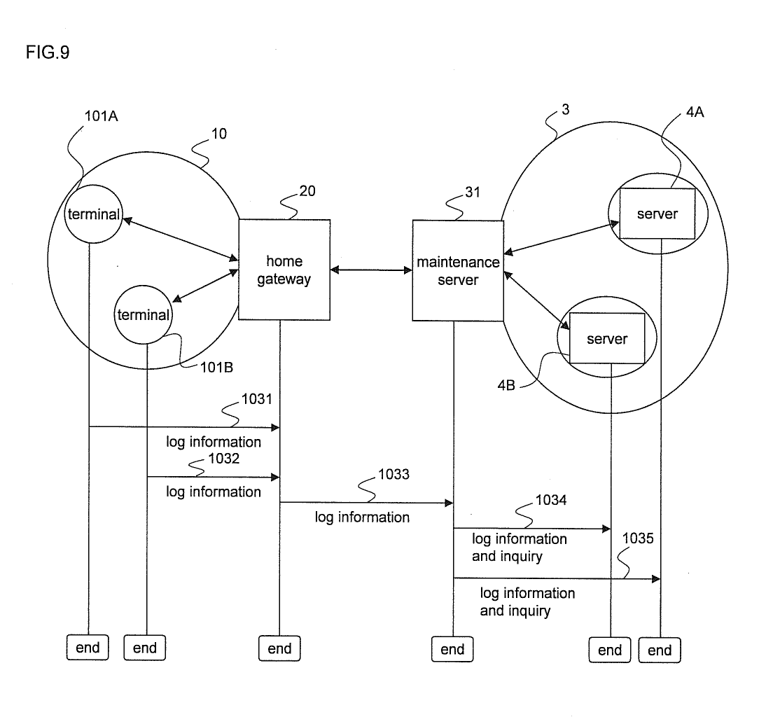

FIG. 9 is a flowchart showing the operating procedure of the present exemplary embodiment.

Terminal 101A and terminal 101B transmit terminal information including log information to maintenance server 31 via home gateway 20 respectively (steps 1031, 1032). Home gateway 20 transfers the terminal information to maintenance server 31 when receiving the terminal information from terminal 101A and terminal 101B (step 1033). When maintenance server 31 receives the terminal information about terminal 101A and terminal 101B respectively from home gateway 20, maintenance server 31 transmits the terminal information about terminal 101A to server 4A and transmits the terminal information about terminal 101B to server 4B to inquire measures (steps 1034, 1035).

Server 4A and server 4B recognize the operating states of the terminals based on the log information included in the received terminal information respectively. When a problem or a failure is recognized in the terminals based on the terminal information, the servers read trouble-shooting information from storage 411 and transmit specific information including the trouble-shooting information to maintenance server 31. For example, as described in the second exemplary embodiment, measures information including a trouble-shooting program is transmitted to the terminals. In this way, it is possible to manage the terminals on the carrier side of network 3 and handle a failure in the terminals.

### Fourth Exemplary Embodiment

In the present exemplary embodiment, server 4A and server 4B check the operating states of the terminals respectively based on log information transferred from maintenance server 31, and cause the terminals to conduct tests for searching for failures in the terminals. The explanation of the same configuration and operations as the first exemplary embodiment is omitted and only points different from the first exemplary embodiment will be specifically described below.

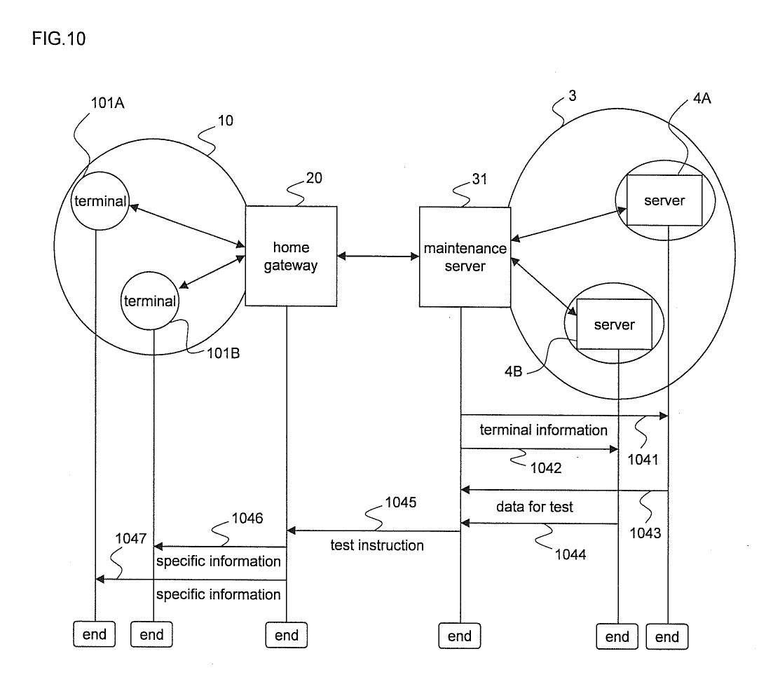

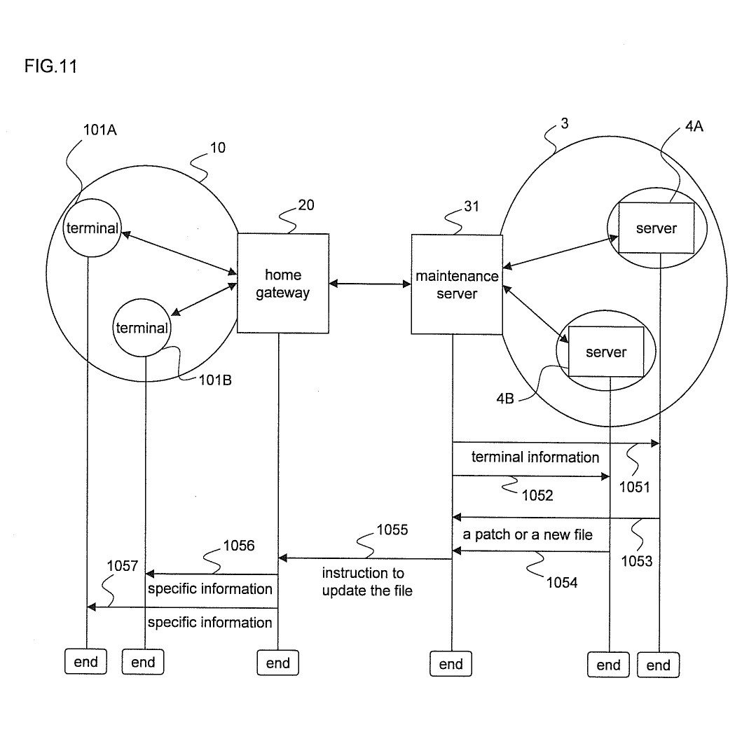

FIG. 10 is a flowchart showing the operating procedure of the present exemplary embodiment. In this case, failures occur in both of terminal 101A and terminal 101B.

As the third exemplary embodiment, server 4A receives, from maintenance server 31, terminal information including log information about terminal 101A (step 1041). Server 4B receives, from maintenance server 31, terminal information including log information about terminal 101B (step 1042). Server 4A and server 4B analyze the terminal information respectively. When the servers decide that more specific information is necessary about the states of the failed terminals, the servers transmit specific information which includes data for additional test and a program for additional test to the corresponding terminals via maintenance server 31 (steps 1043, 1044).

When maintenance server 31 receives the specific information from server 4A and server 4B, maintenance server 31 transmits the specific information including test instruction information to terminal 101A and terminal 101B via home gateway 20 (step 1045). Home gateway 20 allocates, to each destination, the specific information received from maintenance server 31 such that specific information from server 4B is transmitted to terminal 101B (step 1046) and specific information from server 4A is transmitted to terminal 101A (step 1047).

When terminal 101A and terminal 101B receive the specific information from home gateway 20 respectively, terminal 101A and terminal 101B execute the program for additional test with the data for additional test. The data for additional test and the program for additional test are included in the specific information. Thereafter, the terminals transmit test result information which indicates test results to the trouble-shooting servers via maintenance server 31 respectively. The trouble-shooting servers receive the test result information from the terminals, analyze the test results to identify failures occurring in the terminals, and may transmit trouble-shooting information for handling the identified failures to the terminals respectively.

In this way, the trouble-shooting server corresponding to a manufacturer of a terminal can remotely cause the terminal to conduct a test, via maintenance server 31. According to the present exemplary embodiment, it is possible to obtain sufficient information from the terminal in the home under management of network 3 and more properly achieve a quick response according to the operating state of the terminal.

### Fifth Exemplary Embodiment

The present exemplary embodiment will describe operations when a file stored in a terminal is remotely updated through maintenance server 31. The explanation of the same configuration and operations as the first exemplary embodiment is omitted and only points different from the first exemplary embodiment will be specifically described below.

In the present exemplary embodiment, a file is updated not only for improving the function of the terminal but also for improving a security function for stored data. Further, updating includes the installation of a program against threat such as a computer virus from the outside. An instruction to update a file in the terminal corresponds to update information for improving the function of the terminal.

FIG. 11 is a flowchart showing the operating procedure of the present exemplary embodiment.

As the third exemplary embodiment, server 4A receives terminal information including log information about terminal 101A from maintenance server 31 (step 1051). Server 4B receives terminal information including log information about terminal 101B from maintenance server 31 (step 1052). Server 4A and server 4B analyze the terminal information respectively. Then, the servers confirm files executed in the terminals respectively. When the servers decide that it is necessary to insert patches or update the files, the servers transmit specific information including the patches or new files to the corresponding terminals via maintenance server 31 respectively (steps 1053, 1054). The patches and the new files may be both included in the specific information.

When maintenance server 31 receives the specific information from server 4A and server 4B, maintenance server 31 transmits the specific information including an instruction to update the files to terminal 101A and terminal 101B via home gateway 20 (step 1055). In this case, “instruction to update the files” includes the insertion of patches. Home gateway 20 allocates, to each destination, the specific information received from maintenance server 31 such that specific information from server 4B is transmitted to terminal 101B (step 1056) and specific information from server 4A is transmitted to terminal 101A (step 1057).

When terminal 101A and terminal 101B receive the specific information from home gateway 20, terminal 101A and terminal 101B read the patches or new files included in the specific information respectively. When the specific information includes a patch, the terminal inserts the patch to the corresponding point of the executed file. When the specific information includes a new file, the terminal updates an executed file to the new file.

In this way, a trouble-shooting server corresponding to a manufacturer of a terminal can remotely cause the terminal to update a file via maintenance server 31. According to the present exemplary embodiment, it is possible to obtain sufficient information from the terminal in the home under management of network 3 and more properly achieve a quick response according to the operating state of the terminal.

### Sixth Exemplary Embodiment

The present exemplary embodiment will describe the recovery of a terminal when the terminal is hard to recover by remote control through maintenance server 31. The explanation of the same configuration and operations as the first exemplary embodiment is omitted and only points different from the first exemplary embodiment will be specifically described below.

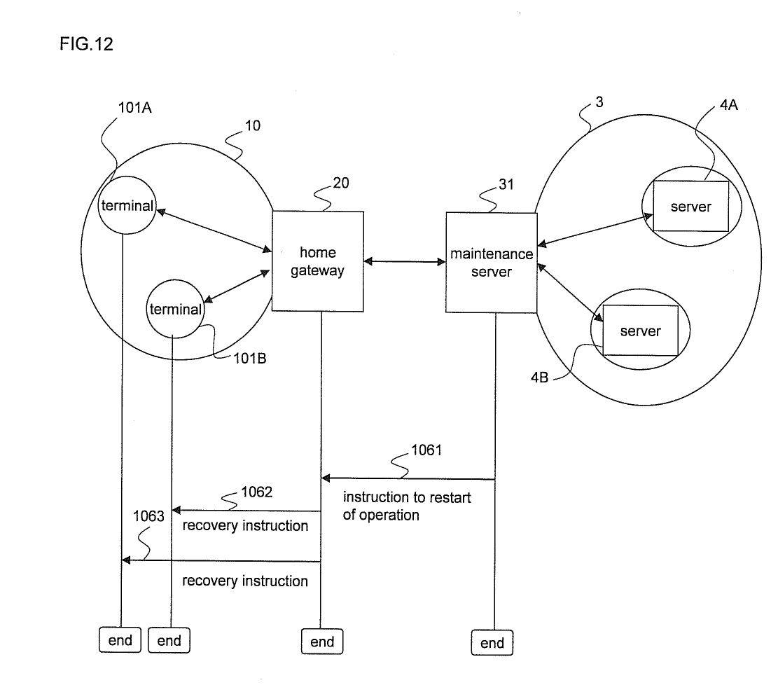

FIG. 12 is a flowchart showing the operating procedure of the present exemplary embodiment. FIG. 12 shows the operating procedure for recovery under management of maintenance server 31 when a critical failure occurs in a terminal or home gateway 20 such that the failure is hard to recover by the terminal or home gateway 20. In this case, failures occur in terminal 101A and terminal 101B.

As described in the first and second exemplary embodiments, maintenance server 31 monitors the states of actions and operations of the terminals based on terminal information received from terminal 101A and terminal 101B. In the event of an unrecoverable failure such as heavy congestion of communications in terminal 101A and terminal 101B, maintenance server 31 recognizes the failure through the terminal information and decides whether or not the failure can be handled by remote control described in the fourth exemplary embodiment. When maintenance server 31 decides that the failure cannot be handled by remote control, maintenance server 31 stops the operations of terminal 101A and terminal 101B.

Thereafter, when terminal 101A and terminal 101B recover, maintenance server 31 confirms that terminal 101A and terminal 101B have returned to normal based on the terminal information received from the terminals. Then, maintenance server 31 transmits a recovery instruction signal for instructing the restart of operations, to the terminals through home gateway 20 (step 1061). Home gateway 20 transmits the recovery instruction signal received from maintenance server 31 to terminal 101A and terminal 101B respectively (steps 1062, 1063).

Terminal 101A and terminal 101B restart the operations respectively when receiving the recovery instruction signal from maintenance server 31. The terminals may recover to restart the operations in response not only to the recovery instruction signal but also to a user operation.

An instruction to stop the operations and recover from a failure is not always provided for one of the failed terminal and home gateway 20. In the event of a failure in the terminal, an instruction to stop the operations and recover from the failure may be provided for home gateway 20 concurrently with an instruction to the terminal.

In this way, when a failure unrecoverable under management of maintenance server 31 occurs in the terminals or home gateway 20 which are connected to home network 10, maintenance server 31 stops the operations of the failed device. Thereafter, when the device recovers from the failure, the operations of the recovered device can be restarted and the device can return to a normal operating state.

The above explanation specifically described the configuration and operations of preferred exemplary embodiments according to the present invention. The exemplary embodiments are merely examples of the present invention and do not limit the present invention. For example, the maintenance server may control accounting for the terminals.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A network communication management system comprising:
a maintenance server connected to a network; and
a terminal connected to said network via a gateway,
wherein said terminal transmits terminal information indicating an operating state of said terminal to said maintenance server via said gateway, and
when said maintenance server receives said terminal information via said gateway, said maintenance server transmits specific information for causing said terminal to perform specific processing based on said terminal information to said terminal via said gateway.

2. A network communication management system comprising:
a maintenance server connected to a network;
a terminal connected to said network via a gateway; and
a trouble-shooting server connected to said network to handle trouble of said terminal,
wherein said terminal transmits terminal information indicating an operating state of said terminal to said maintenance server via said gateway,
said maintenance server transmits said terminal information received via said gateway to said trouble-shooting sever,
said trouble-shooting server recognizes said operating state of said terminal based on said terminal information received from said maintenance server and transmits specific information for causing said terminal to perform specific processing according to recognized said operating state to said maintenance server, and
said maintenance server transmits said specific information received from said trouble-shooting server to said terminal via said gateway.

3. The network communication management system according to claim 1, wherein said terminal information includes model information about said terminal or information indicating whether said terminal operates normally or abnormally.

4. The network communication management system according to claim 2, wherein said terminal information includes model information about said terminal or information indicating whether said terminal operates normally or abnormally.

5. The network communication management system according to claim 1, wherein said terminal information is log information indicating history of said operating states of said terminal.

6. The network communication management system according to claim 2, wherein said terminal information is log information indicating history of said operating states of said terminal.

7. The network communication management system according to claim 1, wherein said gateway transmits information obtained from said terminal information to said maintenance server.

8. The network communication management system according to claim 2, wherein said gateway transmits information obtained from said terminal information to said maintenance server.

9. The network communication management system according to claim 1, wherein when said terminal information is abnormality information indicating an abnormality of said terminal, said specific information is information for causing said terminal to perform said specific processing for handling said abnormality.

10. The network communication management system according to claim 2, wherein when said terminal information is abnormality information indicating an abnormality of said terminal, said specific information is information for causing said terminal to perform said specific processing for handling said abnormality.

11. The network communication management system according to claim 1, wherein said terminal transmits said terminal information to said maintenance server via said gateway when receiving instruction information from said maintenance server.

12. The network communication management system according to claim 2, wherein said terminal transmits said terminal information to said maintenance server via said gateway when receiving instruction information from said maintenance server.

13. The network communication management system according to claim 2, wherein when said terminal information is log information indicating history of said operating states of said terminal, said trouble-shooting server recognizes said operating state of said terminal based on received terminal information and adds, to said specific information, test information for causing said terminal to conduct a test for additionally obtaining information about said operating state of said terminal,
when receiving said specific information from said maintenance server, said terminal conducts a test based on said test information included in said specific information, and transmits test result information indicating a result of said test to said maintenance server,
said maintenance server transmits said test result information received from said terminal to said trouble-shooting server, and
when said trouble-shooting server receives said test result information from said maintenance server and said test result information indicates an abnormality of said terminal, said trouble-shooting server transmits, to said terminal via said maintenance server and said gateway, trouble-shooting information for causing said terminal to perform processing necessary for recovering an operation of said terminal.

14. The network communication management system according to claim 2, wherein said trouble-shooting server recognizes said operating state of said terminal based on said terminal information received from said maintenance server and adds update information for improving a function of said terminal to said specific information, and
when receiving said specific information from said maintenance server, said terminal performs an updating operation based on said update information included in said specific information.

15. The network communication management system according to claim 1, wherein said maintenance server recognizes from said terminal information that a failure occurs in said gateway or said terminal, and decides whether or not said failure can be handled by remote control, and stops an operation of said failed device when deciding that said failure cannot be handled by remote control, and transmits a recovery instruction signal for instructing restart of an operation to recovered device when failed device recovers.

16. The network communication management system according to claim 1, wherein said terminal is connected to said gateway via a network different from said network.

17. The network communication management system according to claim 2, wherein said terminal is connected to said gateway via a network different from said network.

18. A terminal connected via a gateway to a server connected to a network, comprising:
a communicator for transmitting terminal information indicating an operating state of said terminal to said server via said gateway; and
a controller for performing specific processing according to specific information when receiving said specific information for performing said specific processing determined by said server based on said terminal information.

19. The terminal according to claim 18, wherein said terminal is connected to said gateway via a network different from said network.

20. The terminal according to claim 18, wherein said terminal information includes log information indicating history of said operating states of said terminal, model information about said terminal, or information indicating whether said terminal operates normally or abnormally.

21. The terminal according to claim 18, wherein said gateway transmits said terminal information obtained from said terminal information by said gateway to said server.

22. A maintenance server connected to a network and a gateway and connected to a terminal via said gateway, comprising:
a storage for storing information about specific processing for said terminal; and
a controller, when receiving terminal information indicating an operating state of said terminal via said gateway, for determining necessary specific processing based on said terminal information, reading said information from said storage, and transmitting specific information for causing said terminal to perform said specific processing to said terminal.

23. A maintenance server connected to a gateway and a network connected to a trouble-shooting server, said maintenance server being connected to a terminal via said gateway, comprising:
a controller, when receiving terminal information indicating an operating state of said terminal from said terminal via said gateway, for transferring said terminal information to said trouble-shooting server via said network, and when receiving specific information being provided for causing said terminal to perform specific processing corresponding to said operating state of said terminal information from said trouble-shooting server, for transmitting said specific information to said terminal via said gateway.

24. The maintenance server according to claim 23, wherein said specific information includes test information for causing said terminal to conduct a test for additionally obtaining information about said operating state of said terminal, and
said controller transmits test result information indicating a result of said test conducted by said terminal according to said test information to said trouble-shooting server when receiving said test result information, and transmits trouble-shooting information being provided for causing said terminal to perform processing necessary for recovery of said terminal to said terminal via said gateway, when receiving said trouble-shooting information from said trouble-shooting server.

25. The maintenance server according to claim 23, wherein said specific information includes update information for improving a function of said terminal, said update information being determined by said trouble-shooting server based on said terminal information.

26. The maintenance server according to claim 22, wherein when said controller recognizes a failure in said terminal based on said terminal information, said controller decides whether or not said failure can be handled by remote control, said controller stops an operation of said terminal when deciding that said failure cannot be handled by remote control, and said controller transmits a recovery instruction signal to said terminal to instruct said terminal to restart said operation when the terminal recovers.

27. The maintenance server according to claim 23, wherein when said controller recognizes a failure in said terminal based on said terminal information, said controller decides whether or not said failure can be handled by remote control, said controller stops an operation of said terminal when deciding that said failure cannot be handled by remote control, and said controller transmits a recovery instruction signal to said terminal to instruct said terminal to restart said operation when the terminal recovers.

28. The maintenance server according to claim 22, wherein said terminal is connected to said gateway via a network different from said network.

29. The maintenance server according to claim 23, wherein said terminal is connected to said gateway via a network different from said network.

30. A network communication management method using a maintenance server connected to a network and a terminal connected to said network via a gateway, comprising:
transmitting terminal information from said terminal to said maintenance server via said gateway, said terminal information indicating an operating state of said terminal; and
transmitting specific information to said terminal via said gateway when said maintenance server receives said terminal information via said gateway, said specific information being provided for causing said terminal to perform specific processing based on said terminal information.

31. A network communication management method using a maintenance server connected to a network, a terminal connected to said network via a gateway, and a trouble-shooting server connected to said network to handle trouble in said terminal, comprising:
said terminal transmits terminal information to said maintenance server via said gateway, said terminal information indicating an operating state of the terminal;
said maintenance server transmits said terminal information received via said gateway to said trouble-shooting server;
said trouble-shooting server recognizes said operating state of said terminal based on said terminal information received from said maintenance server and transmits specific information for causing said terminal to perform specific processing corresponding to recognized operating state to said maintenance server; and
said maintenance server transmits said specific information received from said trouble-shooting server to said terminal via said gateway.

32. The network communication management method according to claim 30, wherein said terminal information is log information indicating history of said operating states of said terminal.

33. The network communication management method according to claim 31, wherein said terminal information is log information indicating history of said operating states of said terminal.

34. The network communication management method according to claim 31, wherein when said terminal information is log information indicating said operating state of said terminal, said trouble-shooting server recognizes said operating state of said terminal based on received terminal information and adds test information to said specific information, said test information being provided for causing said terminal to conduct a test for additionally obtaining information about said operating state of said terminal,
said terminal conducts, when receiving said specific information from said maintenance server, said test based on said test information included in said specific information and transmits test result information indicating a result of said test to said maintenance server,
said maintenance server transmits said test result information received from said terminal to said trouble-shooting server, and
said trouble-shooting server receives said test result information from said maintenance server, and transmits trouble-shooting information to said terminal via said maintenance server and said gateway when said test result information indicates an abnormality of said terminal, said trouble-shooting information being provided for causing said terminal to perform processing necessary for recovery of said terminal.

35. The network communication management method according to claim 31, wherein said trouble-shooting server recognizes said operating state of said terminal based on said terminal information received from said maintenance server and adds update information for improving a function of said terminal to said specific information, and
said terminal performs, when receiving said specific information from said maintenance server, an updating operation based on said update information included in said specific information.

36. The network communication management method according to claim 30, wherein said maintenance server recognizes from said terminal information that a failure occurs in said gateway or said terminal, decides whether or not said failure can be handled by remote control, stops an operation of failed device when deciding that said failure cannot be handled by remote control, and transmits a recovery instruction signal for instructing restart of an operation to recovered device when failed device recovers.

37. The network communication management method according to claim 31, wherein said maintenance server recognizes from said terminal information that a failure occurs in said gateway or said terminal, decides whether or not said failure can be handled by remote control, stops an operation of failed device when deciding that said failure cannot be handled by remote control, and transmits a recovery instruction signal for instructing restart of an operation to recovered device when failed device recovers.

38. The network communication management method according to claim 30, wherein said terminal is connected to said gateway via a network different from said network.

39. The network communication management method according to claim 31, wherein said terminal is connected to said gateway via a network different from said network.

40. A computer program product for being executed by a computer connected to a network and a gateway, and connected to a terminal via said gateway, said program enabling said computer to perform a process comprising:
determining necessary specific processing based on terminal information when receiving said terminal information indicating an operating state of said terminal via said gateway, and
transmitting specific information for causing said terminal to perform determined specific processing to the terminal.

41. A computer program product for being executed by a computer connected to a gateway and a network connected to a trouble-shooting server, and connected to a terminal via said gateway, said program enabling said computer to perform a process comprising:
transferring terminal information indicating an operating state of said terminal to said trouble-shooting server via said network when receiving said terminal information from said terminal via said gateway, and
transmitting specific information for causing said terminal to perform specific processing corresponding to said operating state of said terminal information to said terminal via said gateway when receiving said specific information from said trouble-shooting server.
